(19) United States
(12) Patent Application Publication
(10) Pub. No.: US 2009/0013078 A1
(43) Pub. Date: Jan. 8, 2009

(54) Optimized Signaling Protocol, Including Session Initiation Protocol (SIP), in a Communications Environment

(75) Inventor: Ahmed Bencheikh, Fairfax Station, VA (US)

Correspondence Address: FENWICK & WEST LLP, SILICON VALLEY CENTER, 801 CALIFORNIA STREET, MOUNTAIN VIEW, CA, 94041, US

(73) Assignee: 4DK TECHNOLOGIES, INC., Herndon, VA (US)

(21) Appl. No.: 11/773,387

(22) Filed: Jul. 3, 2007

(51) Int. Cl. G06F 15/16

(52) U.S. Cl. 709/227

(57) ABSTRACT

A redacted version of a signaling protocol, such as Session Initiation Protocol (SIP), is used to optimize call session communications between a communications terminal and a proxy server. During a session registration process, the proxy server captures and stores session context data by leveraging the content of the registration messages. With the session context data stored at the proxy server, the messages between the proxy server and the communications terminal may omit some or all of the session context data. For outgoing messages, a proxy server receives a redacted signaling message from the communications terminal, reconstructs a standard signaling message from the redacted signaling message, and forwards the reconstructed message to a recipient. For incoming messages, the proxy server receives a standard signaling message, redacts the standard message to remove some or all of the session context data, and forwards the redacted message to the communications terminal.

### BACKGROUND

This invention relates generally to communications systems, and in particular to optimizing signaling communications between signaling network entities in a communications environment.

Existing signaling protocols, such as Session Initiation Protocol (SIP), are used for creating session-oriented connections between two or more IP endpoints in an IP network. A session could be a simple two-way telephone call, a well elaborate collaborative multimedia conferencing application involving voice communications, file and video sharing, white boarding, along with many other types of applications. With SIP, many innovative network services become possible, such as voice-enriched e-commerce, web page click-to-dial, Instant Messaging with buddy lists, Push-to-Talk (PTT), voice-over-IP (VoIP), and IP Centrex services along with many other types of services. SIP has also been adopted by 3rd Generation Partnership Project (3GPP) and by 3GPP2 as the protocol of choice for signaling and call control in IP Multimedia Subsystem (IMS).

SIP has been developed as a Peer-to-Peer (P2P) protocol. It relies on the SIP end points, commonly called SIP User Agent (UA), to negotiate all the characteristics and parameters of a session using text-based SIP and Session Description Protocol (SDP) headers at session establishment phase. The consequence of this negotiation is a very large volume of information transfer between SIP entities. A typical SIP message ranges from few hundred bytes to more than two thousand bytes. While this may not be an issue in some wireline networks, it becomes a real challenge in wireless access networks. The bandwidth needed to transport SIP message increases, and so does the risk of transmission errors, memory, and power needed to process it. Furthermore, SIP text-based encoding makes SIP messages grow dramatically as soon as several extensions are used at the same time. This poses serious challenges to achieve cost effective, high performance carrier grade and differentiating user experience for real-time applications, such as mobile VoIP.

Due to the size and number of signaling messages required to establish a session, the use of SIP in certain applications may cause significant inefficiencies. For example, SIP is not optimized for wireless over the air environments. Large SIP messages have serious disadvantages when used in a wireless environment. For example, service behavior is too slow on relatively low-bandwidth links like the most common wireless signaling channels. If a SIP message is larger than the maximum size that a link layer can handle, the message will be fragmented. If one of the fragments is lost, the sender needs to retransmit the whole message, which degrades user experience. In addition to the length of SIP messages, SIP requires a multitude of messages to establish a session between the SIP endpoints.

To reduce the size and number of SIP messages required to establish a session, telecommunications industry has focused on compressing SIP messages for use over wireless links. For example, compressing SIP using SigComp described by RFC 3320, Text-based Compressing using Cache and Blank (TCCB) approach, or other mechanisms help reduce the size of SIP messages. But the SIP message body may remain too large, even after compression. To improve compression efficiency, a compression algorithm must be implemented in all network entities involved in a session establishment, such as UA and signaling proxy server, using SigComp. But this requirement may easily become a bottleneck and add to overall latency. The impact of having a compressor on a handset in terms of battery, processor, and memory is also unknown. Furthermore, due to the scalability and limited memory storage on a typical handset, maintaining a persistent state in the UA across call/sessions may not be a viable solution.

Accordingly, what is needed is a signaling framework for communications networks that optimizes the currently existing signaling protocols, such as SIP, to reduce the size and/or number of signaling messages exchanged between a user device and the network.

### SUMMARY

To reduce the size and/or number of messages required in a signaling communications protocol, such as SIP, embodiments of the invention optimize the signaling messages by reducing header information and/or the number of signaling messages exchanged. The optimization techniques may be used in a variety of applications, such as communications in a wireless environment.

In one embodiment, during the session registration between a communication device and a proxy server, the proxy server captures and retains certain header information that defines the characteristics of the session. For subsequent communications between the communication device and the proxy server, the communication device and proxy server can use a redacted version of a signaling protocol, for example, by eliminating the captured session information. For outbound communications, the proxy server receives a redacted signaling message from the communication device, reconstructs the signaling message, and forwards the reconstructed messaged to the destination. For inbound communications, the proxy server receives a signaling message, converts the message to a redacted signaling message, and forwards the redacted message to the communication device. In this way, the system uses the cached header information obtained during session establishment to reduce the information needed in the messages transmitted between the communication device and the proxy server. Consequently, the optimization is easily applicable to any session signaling protocols without any prior knowledge of the protocols.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

FIG. 1 is a high-level diagram illustrating an environment for enabling optimized signaling communications between signaling network entities, in accordance with an embodiment of the invention.

FIG. 2 illustrates a session context data (SSC) establishment for optimized signaling communications, in accordance with an embodiment of the invention.

FIG. 3 illustrates a data structure for the session context data, in accordance with an embodiment of the invention.

FIG. 4 illustrates outbound and inbound communications using session context data to optimize signaling communications between network entities, in accordance with an embodiment of the invention.

FIG. 5 is a flow chart illustrating the negotiation for redacted signaling message support between a communications terminal and a SIP proxy server, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview of Optimized Signaling Communications

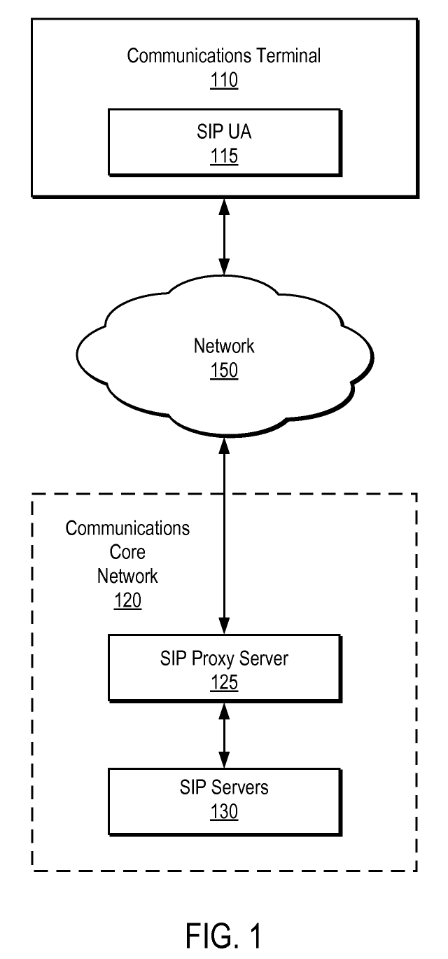

FIG. 1 is a high-level diagram illustrating an environment for enabling optimized signaling communications between signaling network entities. The environment according to one embodiment comprises a communications terminal 110 communicating with a communications core network 120 via a network 150. The communications terminal 110 and the communications core network 120 use signaling messages according to standard Session Initiation Protocol (SIP) message format and/or a redacted version of the signaling message format. In other embodiments of the invention, signaling protocols other than SIP may be used.

The communications terminal 110 has a SIP user agent (UA) 115 running for communications with the communications core network 120. The communications terminal 110 may be a personal computer (PC), a mobile phone, a wireless handhold, a personal digital assistant (PDA), or any other electronic computing device. For explanation purposes, only one communications terminal 110 and one communications core network 120 are depicted in FIG. 1; however, in practice there may be multiple communications terminals 110 communicating with one or more communications core networks 120.

To communicate with the communications core network 120, the SIP UA 115 sends a signaling request message to a SIP proxy server 125 associated with the communications terminal 110, and receives a signaling response messages from the SIP proxy server 125. The signaling messages sent by or destined to the communications terminal 110 may be in a standard SIP message format or in a redacted signaling message format, described below.

The communications core network 120 comprises a SIP proxy server 125 and one or more SIP servers 130 to process SIP signaling messages. The SIP proxy server 125 is associated with one or more communications terminals 110 and forwards each signaling message sent by or destined to the communications terminal 110 associated with the SIP proxy server 125. The SIP servers 130 receive the SIP signaling messages forwarded from the SIP proxy server 125, further process signaling messages and send the messages to a recipient communication terminal 110. For example, in an IP Multimedia Subsystem (IMS) framework for delivering IP multimedia services to end users, the SIP proxy server 125 and SIP servers 130 provide several call/session control functionalities, collectively called Call Session Control Function (CSCF), to process SIP signaling messages in the IMS. A Proxy-CSCF (P-CSCF) is a SIP proxy server 125 that forwards each SIP signaling message send by or destined for an IMS communications terminal 110. Two SIP servers 130, Interrogating-CSCF (I-CSCF), and Serving-CSCF (S-CSCF), further process the SIP signaling messages forwarded from the P-CSCF.

In one embodiment, the SIP proxy server 125 receives a signaling request message in the redacted signaling message format from the SIP UA 115. The SIP proxy server 125 reconstructs a standard SIP request message from the redacted signaling message received from the SIP UA 115, and forwards the reconstructed standard SIP request message to the SIP servers 130. In another embodiment, the SIP proxy server 125 receives a signaling response message in standard SIP message format destined to the communications terminal 110. The SIP proxy server 125 redacts the received SIP response message to a signaling message in the redacted signaling message format, and forwards the redacted signaling message to the SIP UA 115.

The network 150 enables communications between the communications terminal 110 and the communications core network 120. In one embodiment, the network 150 uses standard communications technologies and/or protocols. Thus, the network 150 may include fixed links using technologies such as Ethernet, integrated services digital network (ISDN), digital subscriber line (DSL), asynchronous transfer mode (ATM), or other fixed links technologies. The network 150 may also support mobile access using technologies such as Wideband Code Division Multiple Access (W-CDMA), CDMA200, Global System for Mobile Communications (GSM), General Packet Radio Service (GPRS), or similar technologies. Further, the network 150 may include wireless access using technologies, such as Wireless Local Area Network (W-LAN), Worldwide Interoperability for Microwave Access (WiMAX), or other wireless technologies.

Similarly, the networking protocols used on the network 150 may include multiprotocol label switching (MPLS), the transmission control protocol/Internet protocol (TCP/IP), the User Datagram Protocol (UDP), the session initiation protocol (SIP), the session description protocol (SDP), the hypertext transport protocol (HTTP), the simple mail transfer protocol (SMTP), the file transfer protocol (FTP), or any other suitable protocol. The data exchanged over the network 150 may be represented using technologies and/or formats including the hypertext markup language (HTML), the extensible markup language (XML), or any other suitable format. In addition, all or some of links may be encrypted using conventional encryption technologies, such as the secure sockets layer (SSL), Secure HTTP and/or virtual private networks (VPNs) or Internet Protocol security (IPsec). In another embodiment, the communications terminal 110 may use custom and/or dedicated data communications technologies instead of, or in addition to, the ones described above.

### Session Context Data (SSC) Establishment

A typical SIP signaling message ranges from few hundred bytes to more than two thousand bytes. The bandwidth needed to transport SIP signaling messages increases, and so does the risk of transmission errors, memory, and power needed to process it, especially in wireless communications environment. To optimize the currently existing SIP signaling communications, various embodiments of the invention use the known information about the characteristics of the session to reduce the size of the SIP signaling message exchanged between the SIP UA 115 and the SIP proxy server 125 associated with the communications terminal 110. The known information about the characteristics of the session, nature of the session, and the additional data learned from the signaling messages exchanged during the SIP registration process are used to establish SIP session context data (SSC) identified by a context identification (ID). The relatively static data and parameters characterizing the session represented by the session context data are cached at the SIP proxy server 125. The SIP UA 115 and the SIP proxy server 125 use the cached SSC data to achieve the optimized signaling communications in terms of optimal use of network resources and call/session establishment delay reduction.

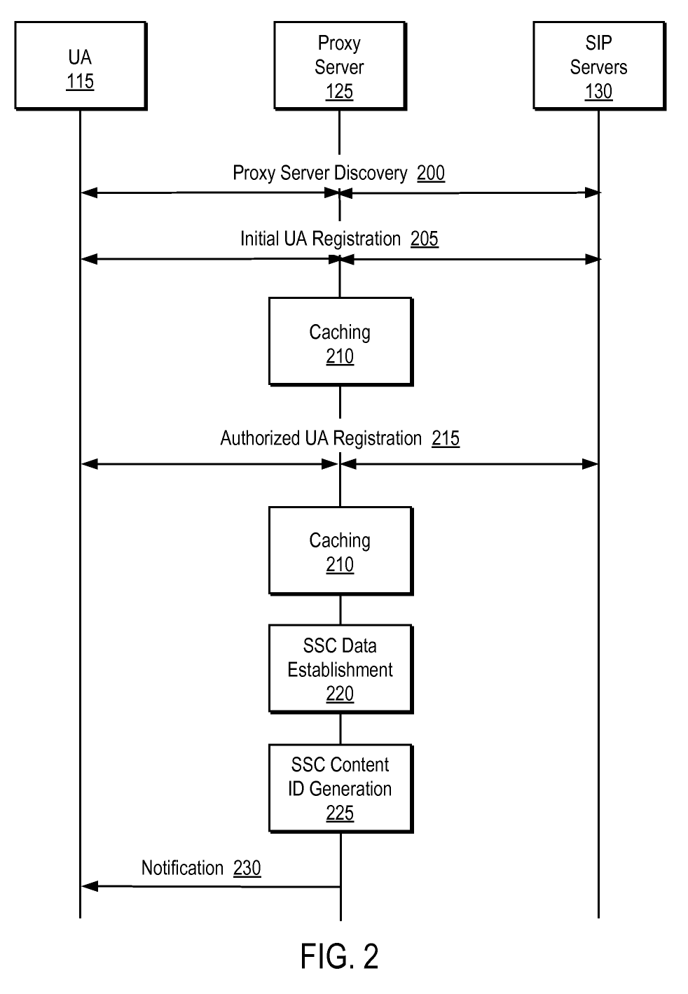

FIG. 2 illustrates session context data establishment for optimized signaling communications in accordance with an embodiment of the invention. The session context data establishment comprises proxy server discovery 200, initial UA registration 205, SSC data component caching 210, authorized UA registration 215, additional SSC data component caching 210, SSC data establishment 220, SSC context ID generation 225 and SSC context data establishment notification 230.

After connecting to the network 150, the communications terminal 110 obtains an IP address of the SIP proxy server 125 by the proxy server discovery process 200. All the SIP signaling messages sent by or destined for the communications terminal 110 traverses the SIP proxy server 125 associated with the communications terminal 110. The communications terminal 110 conventionally discovers the IP address of its associated SIP proxy server 125 with either Dynamic Host Configuration Protocol (DHCP), or it may be assigned an IP address for its associated SIP proxy server 125 using Packet Data Protocol (PDP) Context in the GPRS framework. Once the communications terminal 110 obtains the IP address of the SIP proxy server 125, the communications terminal 110 uses the same IP address to communicate with the SIP proxy server 125 as long as the communications terminal 110 does not initiate a new registration.

The communications terminal 110 registers with the communications core network 120 before the communications terminal 110 can establish any session. In one embodiment, the communications terminal 110 registration procedure uses SIP REGISTER request method. The communications terminal 110 completes the registration procedure in two rounds of registration process, the initial UA registration 205 and the authorized UA registration 215, as shown in FIG. 2. The two-round nature of the registration procedure is common in session signaling communications, such as the wireless communications in the IMS framework. The SIP UA 115 running in the communications terminal 110 sends a UA initial registration message without authentication credentials. It receives a challenge from the SIP servers 130 in a SIP response message. The SIP UA 115 responds back with another registration request that includes the authentication credentials. After passing the authentication credentials checking by the SIP server 130, the SIP UA 115 receives a response from the SIP servers 130 indicating the completion of the registration procedure.

In one embodiment, in response to the received SIP REGISTER request from the SIP UA 115 during the initial UA registration 205, the SIP proxy server 125 captures the session context data components and stores 210 the session context data components in a local cache or other memory at the SIP proxy server 125. In response to the received SIP REGISTER request from the SIP UA 115 during the authorized UA registration 215, the SIP proxy server 125 captures and stores 210 additional session context data components in its local cache. With the cached SSC data components, the SIP proxy server 125 establishes the session context data via SSC data establishment 220, generates 225 a SSC context ID associated with the SSC data, and notifies 230 the SIP UA 115 of the generated SSC context ID.

In one embodiment, the context ID of the SSC data is encrypted for security purposes. An encrypted version of the context ID, called Integrity Key or IKEY, is used for authenticating the signaling messages and source of the signaling messages. The IKEY is generated by the communications terminal 110 and validated by the SIP proxy server 125 associated with the terminal 110. The input to an encryption algorithm includes the IP address, port numbers, the context ID of the SSC data and time in one embodiment. The result is a unique IKEY generated by the communications terminal 110. The SIP proxy server 125 calculates the server IKEY using the same input and same encryption algorithm. If the IKEYs generated by the communications terminal 110 and the SIP proxy server 125 match, the signaling message is considered authenticated. The context ID may be refreshed periodically after a period of time, such as Time To Live (TTL). Thus, the invention improves the level of security while reducing the size of the signaling message sent over the air between the communications terminal 110 and the SIP proxy server 125.

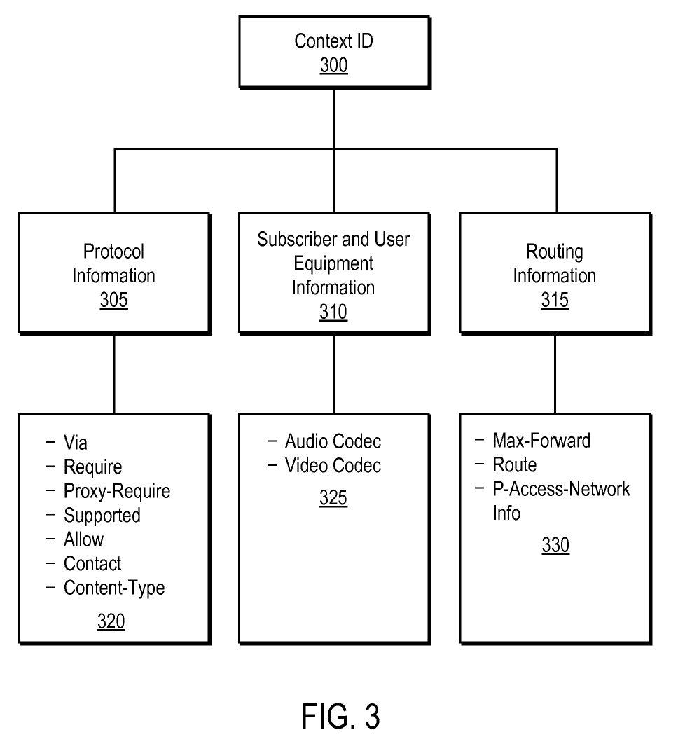

The session context data components captured during the session registration procedure include one or more SIP Header Fields, and/or session description parameters. In the example embodiments described below, the session description parameters comprise SDP Headers; however, other types of session description parameters may be used in other implementations. FIG. 3 illustrates a data structure of the session context data in accordance with an embodiment of the invention. The session context data comprises a SSC context ID 300 identifying the cached session context data, session protocol information 305, session subscriber and user equipment information 310, and session routing information 315 that is used to route session messages.

In one embodiment, the session protocol information 305 comprises one or more SIP Header Fields from a list of SIP Header Fields 320, including Via, Require, Proxy-Require, Supported, Allow, Contact and Content-Type.

In one embodiment, the subscriber and user equipment information 310 comprises one or more SIP Header Fields and one or more SDP Headers 325, including M SDP Header for media type. The media type can be audio, video, text, image, or any other suitable type of media content.

In one embodiment, the session routing information 315 comprises one or more SIP Header Fields from a list of SIP Header Fields 330, including Max-Forwards, Route and P-Access-Network-Info. In one embodiment, session routing information 315 obtained through the SIP Header Fields 330, such as, Max-Forwards, Route and P-Access-Network-Info, are not pre-provisioned or predefined, but instead are collected on the fly from the SIP registration messages. In another embodiment, some session routing information 315 obtained through the SIP Header Fields 330, such as Max-Forwards, is stored in a system database as system configuration parameters. The SIP proxy server 125 may use the stored configuration parameters to construct/redact signaling messages.

One optimization of signaling communications achieved by an embodiment of the invention can be illustrated by examining the standard SIP REGISTER and INVITE messages examples. The following is an example of an initial REGISTER request sent by the IMS terminal 110 to the SIP proxy server 125 (P-CSCF) after the SIP proxy server discovery 200 in the IMS framework.

```
REGISTER sip: home1.net SIP/2.0
Via: SIP/2.0/UDP [1080: :8:800:200C:417A] ; comp=sigcomp;
    Branch=z9hG4bK9h9ab
Max-Forwards: 70
P-Access-Network-Info: 3GPP-UTRAN-TDD;
utran-cell-id-3gpp=C359A3913B20E
From: <sip:alice@home1.net>; tag=s8732n
To: <sip:alice@home1.net>
Contact: <sip: [1080: :8:800:200C:417A]; comp=sigcomp>;
expires=600000
Call-ID: 23fi57lju
Authorization: Digest username=alice_private@home1.net,
        realm=”home1.net”, none=” ”,
        uri=”sip:home1.net”, response=””
Security-Client: ipsec-3gpp; alg=hmac-sha-1-96;
          spi-c=3929102; spi-s=0293020;
          port-c:3333; port-s=5059
Require: sec-agree
Proxy-Require: sec-agree
Cseq: 1 REGISTER
Supported: path
Content-Length: 0
```

With the help of the SIP proxy server 125, the IMS terminal 110 sends the authenticated signaling message during the authorized UA registration 215 phase via the following SIP REGISTER message containing the authorization credentials. The message is routed from the proxy server 125 to the SIP servers I/S-CSCF 130 serving the IMS terminal 110.

```
REGISTER sip: home1.netSIP/2.0
Via: SIP/2.0/UDP [1080: :8:800:200C:417A] ; comp=sigcomp;
Branch=z9hG4bK9h9ab
Max-Forwards: 70
P-Access-Network-Info: 3GPP-UTRAN-TDD;
utran-cell-id-3gpp=C359A3913B20E
From: <sip:alice@home1.net>; tag=s8732n
To: <sip:alice@home1.net>
Contact: <sip: [1080: :8:800:200C:417A]; comp=sigcomp>;
expires=600000
Call-ID: 23fi57lju
Authorization: Digest username=alice_private@home1.net,
        realm=”home1.net”, nonce=”alphanumeric string”,
        algorithm=AKAv1-MD5,
        uri=”sip:home1.net”, response=”alphanumeric string”,
Security-Verify: ipsec-3gpp; q=0.1; alg=hmac-sha-1-96;
          spi-c=909767; spi-s=421909;
          port-c:4444; port-s=5058
Require: sec-agree
Proxy-Require: sec-agree
Cseq:2 REGISTER
Supported: path
Content-Length: 0
```

Once the IMS terminal 110 is registered with the communications core network 120, the IMS terminal 110 initiates a SIP session using SIP INVITE method. The following is an example of SIP INVITE message.

INVITE sip:bob@home2.net SIP/2.0
Via: SIP/2.0/UDP [1080: :8:800:200C:417A]: 5059 ; comp=sigcomp;
Branch=z9hG4bK9h9ab
Max-Forwards: 70
Route: <sip:pcscf1.visited1.net :5058;lr ; comp=sigcomp >,
<sip:orig@scscf1.home1.net;lr>
P-Preferred-Identity: “Alice Smith” <sip: alice@home1.net>
Privacy: none
P-Access-Network-Info: 3GPP-UTRAN-TDD;
utran-cell-id-3gpp=C359A3913B20E
From: <sip:alice@home1.net>; tag=ty20s
To: <sip:bob@home2.net>
Call-ID: 3s09cs03
Cseq: 127 INVITE
Require: precondition, sec-agree
Proxy-Require: sec-agree
Supported: 100rel
Security-Verify: ipsec-3gpp; q=0.1; alg=hmac-sha-1-96;
spi-c=909767; spi-s=421909;
port-c:4444; port-s=5058
Contact: <sip: [1080: :8:800:200C:417A]:5059; comp=sigcomp>
Allow: INVITE, ACK, CANCEL, BYE, PRACK, UPDATE,
REFER, MESSAGE
Content-Type: application/sdp
Content-Length: 569
v=0
o=− 1073055600 IN IP6 1080: :8:800:200C:417A
s=−
c=IN IP6 1080: :8:800:200C:417A
t=0 0
m=video 8382 RTP/AVP 98 99
b=AS:75
a=curr:qos local none
a=curr:qos remote none
a=des:qos mandatory local sendrecv
a=rtpmap:98 H263
a=fmtp:98 profile-level-id=0
a=rtpmap:99 MP4V-ES
m=audio 8283 RTP/AVP 97 96
b=AS:25.4
a=curr:qos local none
a=curr:qos remote none
a=des:qos mandatory local sendrecv
a=des:qos none remote sendrecv
a=rtpmap :97 AMR
a=fmtp :97 mode-set=0, 2, 5, 7 ; maxframe=2
a=rtpmap:96 telephone-event

The REGISTER and INVITE message examples above illustrate the level of redundancy within the messages and between session message exchanges. For instance, the IP address of an originator communications terminal 110 (i.e. 1080::8:800:200C:417A) of the SIP request is repeated in the Via and Contact headers as well as in the o (origin) and c (connection) fields of the SDP header. Furthermore, most of the information being transmitted is redundant with the content of the registration messages exchanged previously, and most of the content does not change during the whole registration period. Most of this known and relatively static information is included in every SIP message (SIP request and SIP response messages) exchanged between the proxy server 125 and the IMS terminal 110. This redundancy increases the load on the network as well as the risk of errors, which impacts the overall session setup latency.

The data learned from the SIP session registration procedure can be further illustrated with reference to the SIP header fields: Via, To, From, Cseq, Call-ID, and Max-Forwards. These fields constitute the six mandatory fields in every SIP signaling message.

The Via header is used to keep track of all the proxies a signaling request traversed. It provides only very little value when used between the proxy server 125 and the communications terminal 110. The proxy server 125 and the communications terminal 110 know each others' IP address during the proxy server discovery 210, and have security association established between them. The routing of the signaling messages can be done without the Via header. In one embodiment, all of the information contained in the Via header is cached by the proxy server 125 during the session registration procedure 205 and/or 215. The subsequent signaling messages sent between the communications terminal 110 and the proxy server 125 after the SSC data establishment do not include the Via header.

The Max-Forwards header is used in SIP signaling communications to avoid routing loops. Every SIP proxy server 125 that handles a signaling request decrements the Max-Forwards value by one. If it reaches to zero, the signaling request is discarded. In one embodiment, the value of the Max-Forwards header is set by the communications terminal 110 at the registration time, and is cached by the SIP proxy server 125 as a component of the SSC data established with the communications terminal 110. After the SSC data establishment, the subsequent signaling messages sent by the communications terminal 110 do not include the Max-Forwards header.

According to SIP specifications, the From, To, and Call-ID header fields transport end-to-end information. The network entities such as the SIP proxy server, and SIP servers, do not assert, inspect or take any action on the values of these headers. In particular, the From header field is not policed. The communications terminal 110 can use any value including a SIP user resource identification (URI) that does not belong to this communications terminal 110. Even if the information contained in these headers is accurate, it is generally redundant with the content of other SIP headers. Thus, in one embodiment of the invention, the signaling message in the redacted signaling message format does not make explicit use of the From, To, Call-ID header fields. The originator communications terminal 110, the universal resource locator (URL) of the originator, and the destination communications terminals 110 are implicitly indicated in front of the header associated with the method being used. For example, using the redacted signaling message format according to one embodiment of the invention, the first line of the INVITE message becomes:
INVITE alice@home1.net, bob@home2.net, P=Y,
   where Alice is the originator (From) and Bob is the destination (To). The identity Alice is using to setup this session (alice@home1 net) will also be used as the preferred identity and will be validated by the SIP proxy server 125. With this embodiment of invention, the originator cannot use a faked caller ID. If necessary, the SIP proxy server 125 adds the From and To headers using the above values (alice@home1.net and bob@home2.net in the example) into the reconstructed SIP message. The SIP proxy server 125 then forwards the reconstructed message to the other SIP entities including the destination communications terminal 110 if the destination communications terminal 110 does not support redacted signaling message format.

The Cseq header field contains a sequence number and a method name. Cseq header field is used to match signaling requests and responses. One embodiment of the invention makes use of Cseq header field as a number value without the header name. The name of the method is also omitted if it is the same as the one in the start line of the message.

The following example illustrates this optimization. In the SIP message format, the partial INVITE message is:

INVITE sip:bob@home2.net SIP/2.0
Via: SIP/2.0/UDP [1080: :8:800:200C:417A]: 5059 ;
comp=sigcomp; Branch=z9hG4bK9h9ab
Max-Forwards: 70
From: <sip:alice@home1.net>; tag=ty20s
To: <sip:bob@home2.net>
Call-ID: 3s09cs03
Cseq:127 INVITE.

With the redacted signaling message format, the above INVITE message becomes:

INVITE alice@home1, net bob@home2.net
3s09cs03, 127

The absence of the method name after the 127 number in Cseq is interpreted by the SIP proxy server 125 as being the same as the name of the request which is the INVITE. The SIP proxy server 125 can add the method name (INVITE) to the Cseq header as part of the reconstruction of the SIP message before the SIP proxy server 125 sends the reconstructed SIP message out to other network entities.

The SIP P-Access-Network-Info header field describes the type of access network being used and the cell ID. In one embodiment of the invention, the type of access being used is cached as a session context data component so that the SIP UA 115 does not have to include this header field in the subsequent signaling messages. If the SIP UA 115 changes the type of access network, the SIP UA 115 re-registers, and the session context data is then updated. If the change of access network does not result in a new SIP registration, the SIP UA 115 may use the “UPDATE” method defined in RFC 3311 or a similar method to report any changes in the session context data.

The SIP Supported header field (Supported: path) is used for the SIP UA 115 to implement new extensions with new headers and message bodies without the need for the intermediate servers, such as the SIP proxy server 125, to understand them. The use of the Support header allows the SIP UA 115 to inform the network 150 and the other SIP UAs 115 of which extensions and features it supports. To avoid the need for including the Supported header field in the INVITE message, one embodiment of the invention includes all the extensions that the SIP UA 115 supports and wants to advertise to the network 150 and other SIP UAs 115 in the Supported header of the REGISTER message as follows:
Supported: option tags.
   In the above, option tags represents the list of all the extensions that SIP UA 115 supports and wants to advertise.

When a SIP session dialog is being established, the SIP UA 115 lists all the names of the SIP extensions it wants to use for that dialog in the Require header field. To avoid transmitting the Require header field with each message after the establishment of the session context data, in one embodiment, the SIP UA 115 indicates during the session registration time, in the Require header, all the names of the SIP extensions it wants to use.

As mentioned above, with SIP, new headers and message bodies can be added without the need for the proxy server 125 to support them. The Proxy-Require header is included in the session request message to indicate the need for the proxy server 125 to activate, understand and interpret the feature provided with this header. These indicated features are mandatory capabilities that the SIP proxy server 125 must support. For example, as required by the 3GPP/3GPP2 standards, the SIP proxy server 125 is required to support the security association established with the SIP UA 125. As the support for security agreement or association is a must for all mobile SIP UAs 115, in one embodiment of the invention, the SIP proxy server 125 supports the security agreement or association by default. Hence there is no need to specify such support explicitly with each message. In another embodiment, this capability as well as others required from the proxy server 125 can be specified once for all in the registration phase and the SIP proxy server 125 caches it as a component of the session context data established with the SIP UA 115. The subsequent signaling messages sent by the communications terminal 110 after the SSC data establishment do not include the Proxy-Require header.

The Contact header field contains the SIP uniform resource identifier (URI) or IP address that can be used to send SIP requests to the SIP UA 115. Practically, the IMS communications terminal 110 is not aware of its URI. The Contact header contains the IP address of the IMS communications terminal 110 and the port number bound to the security association and used for receiving SIP messages. This information is redundant and is provided to the SIP proxy server 125 at the registration phase. There is no need to send it with each message exchange after the session context data is established and the established security association remains active. If the IP address of the SIP UA 115 changes, the SIP UA 115 sends an update message to the SIP proxy server 125 to update its cached session context data.

Using one or more of the above techniques may significantly reduce the size of the SIP messages (especially the INVITE message) exchanged between the terminal 115 and the proxy server 125 after the session context data establishment 220 is completed. One embodiment of the invention further reduces the signaling message size by handling the other SIP headers fields appropriately, as demonstrated in the following, which continues with the example of the INVITE message described above.

In addition to the option tags used with Require and Supported to indicate the SIP extensions supported or desired, SIP can also be extended by defining other methods. In a SIP session dialog, the SIP UAs 115 need to know the methods supported by each other. Each UA 115 lists all the methods it supports in the Allow header field and sends the listed methods to the destination communications terminal 110. For example, as the IMS communications terminal 110 connecting to an IMS core network 120 must be IMS compliant, the IMS communications terminal 110 is expected to support some extensions, at least the basic ones that are part of the call flow (like INVITE, BYE, ACK, PRACK, etc.). The methods required for supporting VoIP are considered as supported by all the registered and authorized SIP UAs 115 by default.

In another embodiment, the SIP UA 115 may advertise all the methods it supports during the session registration with the IMS core network 120. The SIP proxy server 125, caches that information as part of the session context data. Hence, the SIP UA 115 does not have to include the Allow header in any message exchange after the establishment of the session context data. The following is an example of the Allow header field:
Allow: INVITE, ACK, CANCEL, BYE, UPDATE, PRACK, REFER.
   The Route header field is used to indicate that the session request needs to be routed through the SIP entities specified in the content of the Route header. The content of the Route header is created from the concatenation of the outbound SIP proxy server 125, learned during the SIP proxy server discovery 210, and the value of the Service-Route header field received in the 200 OK response to the REGISTER request. In one embodiment of the invention, the SIP proxy server 125, maintains, as part of the session context data, the address of the SIP servers 130 that need to be traversed. The IP address of the proxy server 125 is known to the SIP UA 115 as a result of the proxy server discovery 200. The message is sent to the appropriate proxy server 125 using its IP. The proxy server 125 adds its own URI address into the Route as part of the composition of the equivalent SIP message from the redacted signaling message. Hence the Route header will not be included in the redacted INVITE once the session context data is established.

The P-Preferred-Identity header field is another extension to SIP specified in the RFC 3325 (Privacy Extensions to SIP for Asserted Identity within Trusted Networks). This header is used by the communications terminal 110 to indicate which one of the communications terminal's 110 identities should be used for the current session. In one embodiment, if the communications terminal 110 has multiple IDs that are used to select services, the preferred identity to use can simply be included in front of the INVITE header in the following manner:
INVITE alice@home.net, bob@home2.net, P=Y,
   indicating that Alice in inviting Bob to establish a session and she wants to use alice@home1.net as preferred identity. The P=Y indicates Alice's desire to preserve her privacy, so her identity will not be visible to Bob. The Privacy is set to none by default allowing the used identity to be visible to the other party. In another embodiment, during the registration process, the SIP proxy server 125 downloads the list of authorized Public Identities to the communications terminal 110. The SIP proxy server 125, keeps the same list in memory so it can validate it when necessary, and simply uses this as an index list. The SIP UA 115 includes the index corresponding to the Public Identity the communications terminal 110 wants to use.

The session description parameter, such as the SDP Header, that is used to describe and negotiate the characteristics of the session contributes significantly to the overall size of the INVITE message. To know when the quality of service (QoS) requirements indicated in the SDP header of the INVITE are met, the SIP UAs 115 exchange SDP messages and send UPDATE messages to inform each others that the QoS conditions are met in their respective access network. This conventional SIP method leads to the additional exchange of messages with long SDP headers. To avoid this situation, in one embodiment of the invention, the communications terminals 110 at the registration time inform the network 150 of their capabilities, such as the codecs (audio, video, audio and video, etc.) they can support for multimedia data. The communications terminals 110 then let the network 150 negotiate and pick the best characteristics of the session and inform the communications terminal 110.

In one embodiment, the network sets up and provides an appropriate level of QoS for a particular session depending, for example, on the capabilities of the device, the subscriber profile, the type of application, and/or the conditions of the network. This provides a capacity-quality tradeoff that would be optimal for both the communications network services providers and their customers. Eventually, the customers are charged according to the level of QoS being provided. Hence, with this embodiment, the QoS precondition is assumed at the start of the session and the SIP UA 115 does not need to explicitly state it in session establishment messages. Avoiding the QoS negotiation between the SIP UA 115 and the network 150 at each call setup and sending UPDATE messages between the two communications terminals 110 involved in the session reduces the number of messages as well as the time required to set up the session.

The message bodies in SIP, such as the SDP body, are transmitted end-to-end. The SIP proxy server 125 and the other SIP entities do not need to parse the message body to route the message. To illustrate the optimization that may be achieved using the session context data, the following Table I identifies some key headers in the SDP body in the IMS framework and how they are used with the redacted SIP format, according to one embodiment of the invention.

TABLE I
Key SDP Headers

| | | Comments Regarding Use in the |
|---|---|---|
| Type | Description | Redacted SIP Message Format |
| V | Version of SDP | Currently 0 (known as part of the SSC data; not |
| | | used after SSC establishment) |
| B | Bandwidth information. IMS terminals always | B = line is optional in SDP. IMS terminals |
| | include a b = line per type of media indicating | include it to give an indication to the network |
| | the bandwidth requirement for that particular | about the bandwidth required. (known as part of |
| | media stream. | the SSC data; not used after SSC establishment) |
| O | Origin or owner of the session and session | Redundant with the content of the other SIP |
| | identifier | headers (Not used) |
| Z | Time zone adjustments | Not used |
| S | Name of the session | Not used |
| K | Encryption key | Not used |
| I | Information about the session and media lines | Not used |
| A | Attributes - | (a = rtpmap:0 PCMJ/8000) Attributes-rtpmap |
| | (a = audio 4006 RTP/AVP 0 4) media type | lists attributes of RTP/AVP audio profile 0 |
| | audio, port number (4006), type (RTP/AVP), | including codec (PCMU -PCM mu-law) and |
| | and number (profiles 0 or 4) | sampling rate (8000 Hz) |
| | (a = rtpmap: 14 MPA/90000) rtpmap lists | (a = rtpmap:4 GSM/8000) Attribute-rtpmap lists |
| | attributes of RTP/AVP video profile 14 | attributes of RTP/AVP audio profile 4 |
| | including codec (MPA) and sampling rate | including codec (GSM) and sampling rate |
| | (90,000 Hz) | (8000 Hz) |
| | (a = rtpmap: 26 JPEG/90000) rtpmap lists | Use: those attributes are known as |
| | attributes of RTP/AVP video profile 26 | characteristics of the applications being used |
| | including codec (JPEG) and sampling rate | and media being transmitted. The network will |
| | (90000 Hz) | pick the best codec and inform the user agents. |
| | | The appropriate level of QoS is provided by the |
| | | network automatically depending on the |
| | | characteristics of the application and media. |
| U | URL containing a description of the session | Not used |
| T | Time - start and stop time - | Not used |
| E | e-mail address to obtain information about the | Not used |
| | session | |
| P | Phone number to obtain information about the | Not used |
| | session | |
| M | Media - media type (audio, video), port | The m = line contains the port number where the |
| | number, type (RTP/AVP), and profile numbers. | terminal wants to receive the media and a list of |
| | m = audio 8283 RTP/AVP 97 96 (used with W- | codecs that it is willing to support for this |
| | SIP in a condensed format) | media stream. (if known as part of the SSC |
| | | data, it may not be used after SSC |
| | | establishment. Otherwise, it can be specified as |
| | | in example below in pragraph [0055]) |
| C | Connection information - Network (IN for | Contains the IP address where the terminal |
| | Internet), address type (IP4 for IP version 4) | wants to receive media streams. This |
| | and IP address | information redundant with the content of the o |
| | | type and with other SIP headers. Not used. |

Using the optimization techniques described above, the INVITE message used in the redacted signaling message format is the following, in accordance with an embodiment of the invention:

INVITE alice@ims1.net , bob@ims2.net, P = Y
Context-ID, Call ID, Cseq
M = video PortNum; audio PortNum; Sync = Y.

In another embodiment, to clarify further the INVITE message in the redacted signaling message format from the one in standard SIP message format, a new method called INITIATE is used for initiating a session instead of the INVITE message. The following is an example of an INITIATE message, which may be equivalent to the standard SIP INVITE message:

INITIATE alice@ims1.net , bob@ims2.net, P = Y
IKey, PrIdIndex, Call ID, Cseq
M = video PortNum; audio PortNum; Sync = Y

The From and To are implicit in this message: From=alice@ims1.net=Preferred Identity, and To=bob@ims2.net. An encrypted context ID, i.e. IKEY, is used as a pointer or index to the session context data for the SIP proxy server 125 to retrieve the agreed upon parameters.

### Session Signaling Communications Optimization

With the session context data establishment, general signaling messages such as INVITE, SUBCRIB, NOTIFY, PRACK, OK, UPDATE, and the like can be optimized with reduced signaling message size and number of signaling messages needed for the signaling communications. The SIP UA 115 sends signaling request messages in the redacted signaling message format to the SIP proxy server 125. The redacted signaling request message has less SIP header fields than required by the SIP message format. In response to the received redacted signaling request message, the SIP proxy server 125 reconstructs the equivalent standard SIP request message from the redacted signaling message by retrieving at least some of the missing header fields from the cached SSC. The SSC data are stored in the SIP proxy server 125 and can be retrieved using a context ID that is shared by the proxy server 125 and the SIP UA 115 that owns the SSC.

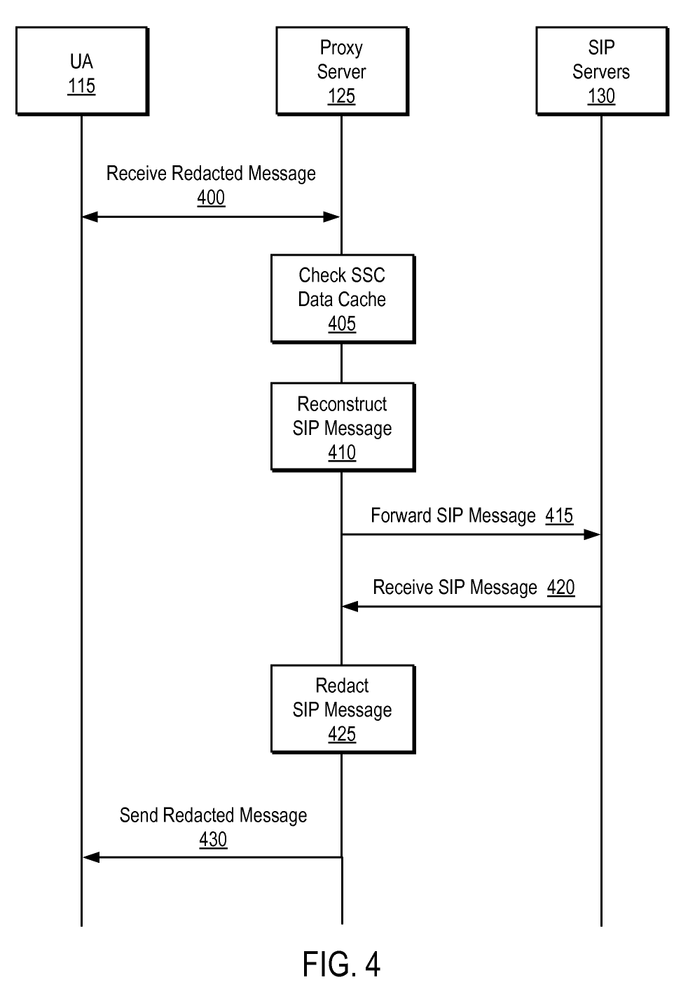

FIG. 4 illustrates the use of session context data to optimize signaling communications between network entities, in accordance with an embodiment of the invention. Using SSC data for signaling communications at the SIP proxy server 125, for outbound messages, comprises receiving 400 the redacted signaling message from the SIP UA 115, checking and retrieving 405 the necessary SSC data cached at the SIP proxy server 125, reconstructing 410 the SIP message from the received redacted signaling message, and forwarding 415 the reconstructed SIP message to the SIP servers 130. For incoming messages, the method comprises receiving 420 SIP message from the SIP servers 130, redacting 425 the received SIP message into a redacted signaling message and sending 430 the redacted SIP message to the communications terminal 110.

For outbound communications, the UA 115 sends 400 a redacted message to the proxy server 125, where the redacted message is created using one or more of the optimization techniques described above. In response to the received redacted signaling message from the communications terminal 110, the SIP proxy server 125 reconstructs 410 a standard SIP message from the redacted signaling message by adding any missing SIP header fields or other data to the redacted signaling message. The proxy server 125 obtains this information by checking 405 the SSC cache stored at the proxy server 125.

The examples from the previous discussion can be used to illustrate how the SIP proxy server 125 reconstructs a standard SIP INVITE message from the redacted INITIATE message. First, the SIP proxy server 125 changes the method name from INITIATE to INVITE and then adds the SIP version information retrieved from the cached SSC data. The SIP proxy server 125 adds the Max-Forwards header as defined by a communications service provider or by the communications terminal 110 at the registration time. The SIP proxy server 125 adds the Via, Route, P-Access-Network-Info, From, To, Contact and Allow headers using the SSC data. The SIP proxy server 125 uses the information in the INITIATE message to reconstruct the Privacy, Call-ID and Cseq headers. The Require and Supported header fields can be added by the SIP proxy server 125 if not assumed as part of the signaling communications. The SIP proxy server 125 populates the P-Asserted-Identity header field with a valid SIP registered Public User Identity of the communications terminal 110 following the procedures specified in RFC 3325. The value could be the same as the one in the INITIATE message (i.e., alice@ims1.net) or any other valid and registered public user ID corresponding to the PrIdIndex specified in the INITIATE message. The SIP proxy server 125 adds the Record-Route and P-Charging-Vector header fields as specified in standard SIP procedures. The Proxy-Require and Security-Verify are local to the SIP proxy server 125 and are not added to the INVITE message. The SIP proxy server 125 adds the Content-Type and Content-Length headers as well as the SDP header constructed based on the type of media session the communications terminal 110 wants to setup and the QoS and Policies defined by the communications service provider. In addition to the SDP header M, the SIP proxy server 125 adds the following SDP headers: V, O, S, C, T, B, and A into the reconstructed SIP message. The SIP proxy server 125 forwards the reconstructed SIP message to the SIP servers 130.

In one embodiment of the invention, when the SIP proxy server 125 receives the INITIATE message request, it validates the QoS requirements with the Policies defined by the communications service provider to make sure that there is enough resource to establish the session. The SIP proxy server 125 reserves the required resources temporarily for the duration of the call setup. If the destined communications terminal 110 accepts the call, the resources are confirmed and attributed to the session; otherwise, the resources are released. This mechanism avoids the need for exchanging multiple signaling messages between the communications terminals 110 and between the communications terminal 110 and the SIP proxy server 125.

In response to the received standard SIP message from the SIP servers 130, for an inbound message, the SIP proxy server 125 redacts the standard SIP message to a redacted signaling message by deleting the appropriate SIP header fields using the appropriate information in the cached SSC data. In one embodiment, the SIP proxy server 125 compares each of the header field of the standard SIP message with the cached SSC data and deletes the header field if it matches the cached SSC data. The SIP proxy server 125 then forwards the redacted signaling message to the communications terminal 110. Consequently, the size as well the structure of the SSC data remains flexible.

Embodiments of the invention are designed to optimize a signaling protocol, such as SIP, by reducing the signaling message size without requiring compression and/or by reducing the number of signaling messages needed to exchange to set up a session, as described above. One benefit of this optimization is to simplify the function logic at the communications terminals 110. The communications terminal 110 does not need to maintain a session state or implement a compressor/decompressor. For example, such optimization reserves power resource and prolongs the battery life of mobile/wireless communications devices.

In another embodiment, the current existing signaling communications protocols, such as SIP, are supported. During the SIP registration phase, the communications terminal 110 indicates its desire to support the redacted signaling message format for session setup and for potentially signaling communications after the session context data establishment. If the SIP proxy server 125 supports the redacted signaling messages, the SIP proxy server 125 collects the necessary session context data components to establish the session context data, creates a unique context ID, and shares it with the communications terminal 110. If the SIP proxy server 125 does not support the redacted signaling messages, the SIP proxy server 125 sends a notification to the SIP UA 115 and continues using the standard SIP messages for the signaling communications.

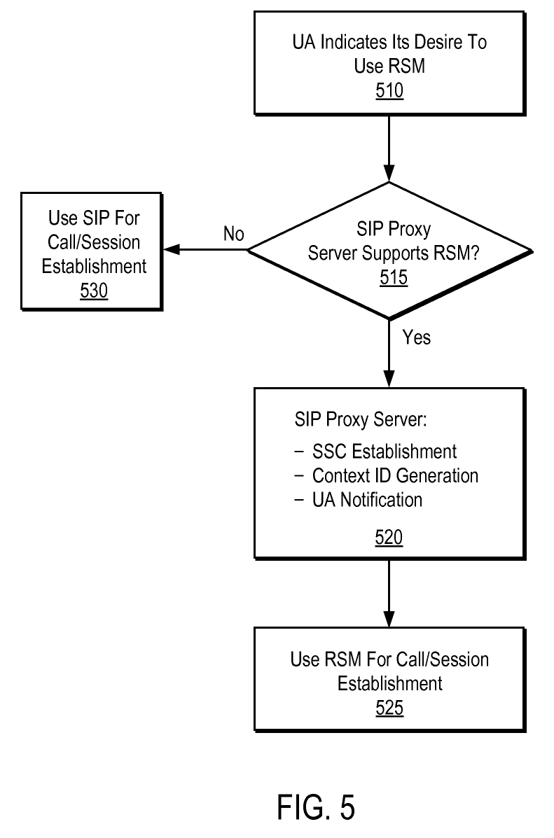

FIG. 5 illustrates the negotiation for the redacted signaling message support between the communications terminal 110 and the SIP proxy server 125, in accordance with an embodiment. The SIP UA 115 indicates 510 its desire to use the redacted signaling message (RSM) by sending regular SIP REGISTER message to the SIP proxy server 125. In response to the received message from the SIP UA 115, if the SIP proxy server 125 supports 515 the redacted signaling message, the SIP proxy server 125 performs 520 the SSC establishment, context ID generation and UA notification. The SIP proxy server 125 uses 525 the redacted signaling messages for call/session establishment. If the SIP proxy server 125 does not support the redacted signaling message, the SIP proxy server 125 uses 530 the standard SIP messages for call/session establishment.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings.

Some portions of above description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof. In addition, the terms used to describe various quantities, data values, and computations are understood to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or the like, refer to the action and processes of a computer system or similar electronic computing device, which manipulates and transforms data represented as physical (electronic) quantities within the computer system memories or registers or other such information storage, transmission, or display devices. Embodiments of the invention may also relate to an apparatus for performing the operations herein. This apparatus may be specially constructed for the required purposes, or it may comprise a general-purpose computing device selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium and modulated or otherwise encoded in a carrier wave transmitted according to any suitable transmission method.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, embodiments of the invention are not described with reference to any particular programming language. It is appreciated that a variety of programming languages may be used to implement various embodiments of the invention as described herein, and any references to specific languages are provided for disclosure of enablement and best mode of embodiments of the invention.

Finally, it should be noted that the language used in the specification has been principally selected for readability and instructional purposes, and it may not have been selected to delineate or circumscribe the inventive subject matter. Accordingly, the disclosure of the embodiments of the invention is intended to be illustrative, but not limiting, of the scope of the invention, which is set forth in the following claims.

What is claimed is:

1. A computer program product for processing inbound and outbound signaling messages at a SIP proxy server, the computer program product comprising a computer-readable medium containing computer program code for:
for inbound signaling messages received at the SIP proxy server:
receiving a redacted signaling message at a proxy server from an originator communications terminal, the redacted signaling message directed to a recipient communications terminal,
reconstructing a SIP message at the proxy server from the redacted signaling message, and
forwarding the reconstructed SIP message to the recipient communications terminal; and
for outbound signaling messages sent by the SIP proxy server:
receiving a SIP message from a communications terminal at a proxy server forwarded by a SIP server, the SIP message directed to a destined communications terminal,
redacting the SIP message at the proxy server to a redacted signaling message, and
forwarding the redacted signaling message to the destined communications terminal.

2. The computer program product of claim 1, the computer-readable medium further comprising computer program code for:
storing session context data at the proxy server in response to a SIP message received from the originator communication terminal during a terminal registration process.

3. The computer program product of claim 2, wherein storing session context data at the proxy server comprises computer program code for:
capturing the session context data using information from the SIP message; and
caching the session context data.

4. The computer program product of claim 3, wherein caching the session context data during the session registration process comprises computer program code for:
caching the session context data during initial registration phase of the terminal registration process.

5. The computer program product of claim 3, wherein caching the session context data during the registration process further comprises computer program code for:
caching additional session context data during re-registration phase of the terminal registration process, initiated by the originator communications terminal.

6. The computer program product of claim 2, wherein storing session context data at the proxy server comprises computer program code for:
generating a context identification (ID) associated with the session context data.

7. The computer program product of claim 2, wherein the session context data stored at the proxy server comprises at least one of session protocol information, subscriber and user equipment information, and session routing information.

8. The computer program product of claim 7, wherein the session protocol information includes at least one SIP header field selected from a group of SIP header fields consisting of: Via, Require, Proxy-Require, Supported, Allow, Contact and Content-Type.

9. The computer program product of claim 7, wherein the session subscriber and user equipment information includes at least one of session description parameters for media type supported, wherein the media type is audio or video.

10. The computer program product of claim 7, wherein the session routing information includes at least one SIP header field selected from a group of SIP header fields consisting of: Max-Forwards, Route, and P-Access-Network-Info.

11. The computer program product of claim 1, wherein the reconstructed SIP message comprises session information from the redacted signaling message and at least a portion of the session context data stored at the proxy server.

12. The computer program product of claim 1, the computer-readable medium further comprising computer program code for:
wherein redacting the SIP message at the proxy server comprises comparing each session header field of the received SIP message with the session context data.

13. The computer program product of claim 12, wherein comparing each header field of the received SIP message with the session context data comprises computer program code for:
comparing the header field of the received SIP message with each selected SIP header field from a group of SIP header fields consisting of: Via, Require, Proxy-Require, Supported, Allow, Contact, Content-Type, Max-Forwards, Route, and P-Access-Network-Info.

14. The computer program product of claim 12, wherein comparing each header field of the received SIP message with the session context data further comprises computer program code for:
comparing the header field of the received SIP message with at least one of session description parameters for media type supported, wherein the media type is audio or video.

15. The computer program product of claim 1, wherein redacting the SIP message at the proxy server further comprises computer program code for:
deleting each session header field from the received SIP message if the session header field is stored in the session context data.

16. A method for processing inbound signaling messages at a SIP proxy server, the method comprising:
receiving a redacted signaling message at a proxy server from an originator communications terminal, the redacted signaling message directed to a recipient communications terminal;
reconstructing a SIP message at the proxy server from the redacted signaling message; and
forwarding the reconstructed SIP message to the recipient communications terminal.

17. The method of claim 16 further comprising:
storing session context data at the proxy server in response to a SIP message received from the originator communication terminal during a terminal registration process.

18. The method of claim 17, wherein storing session context data at the proxy server comprises:
capturing the session context data using information from the SIP message; and
caching the session context data.

19. The method of claim 18, wherein caching the session context data during the session registration process comprises caching the session context data during initial registration phase of the terminal registration process.

20. The method of claim 18, wherein caching the session context data during the registration process further comprises caching additional session context data during re-registration phase of the terminal registration process, initiated by the originator communications terminal.

21. The method of claim 16, wherein storing session context data at the proxy server comprises generating a context identification (ID) associated with the session context data.

22. The method of claim 17, wherein the session context data stored at the proxy server comprises at least one of session protocol information, subscriber and user equipment information, and session routing information.

23. The method of claim 22, wherein the session protocol information includes at least one SIP header field selected from a group of SIP header fields consisting of: Via, Require, Proxy-Require, Supported, Allow, Contact and Content-Type.

24. The method of claim 22, wherein the session subscriber and user equipment information includes at least one of session description parameters for media type supported, wherein the media type is audio or video.

25. The method of claim 22, wherein the session routing information includes at least one SIP header field selected from a group of SIP header fields consisting of: Max-Forwards, Route, and P-Access-Network-Info.

26. The method of claim 16, wherein the reconstructed SIP message comprises session information from the redacted signaling message and at least a portion of the session context data stored at the proxy server.

27. A method for processing outbound signaling messages at a SIP proxy server, the method comprising:
receiving a SIP message from a communications terminal at a proxy server forwarded by a SIP server, the SIP message directed to a destined communications terminal;
redacting the SIP message at the proxy server to a redacted signaling message; and
forwarding the redacted signaling message to the destined communications terminal.

28. The method of claim 27, further comprising:
wherein redacting the SIP message at the proxy server comprises comparing each session header field of the received SIP message with the session context data.

29. The method of claim 28, wherein comparing each header field of the received SIP message with the session context data comprises comparing the header field of the received SIP message with each selected SIP header field from a group of SIP header fields consisting of: Via, Require, Proxy-Require, Supported, Allow, Contact, Content-Type, Max-Forwards, Route, and P-Access-Network-Info.

30. The method of claim 28, wherein comparing each header field of the received SIP message with the session context data further comprises comparing the header field of the received SIP message with at least one of session description parameters for media type supported, wherein the media type is audio or video.

31. The method of claim 27, wherein redacting the SIP message at the proxy server further comprises deleting each session header field from the received SIP message if the session header field is stored in the session context data.

32. A computer program product for communicating by a communications terminal with another network entity in a communications network, the computer program product comprising a computer-readable medium containing computer program code for:
registering with a communications core network through a proxy server using a SIP message;
sending a redacted signaling message to a recipient communications terminal through the proxy server, the redacted signaling message having fewer SIP header fields than a standard SIP message; and
receiving a redacted signaling message forwarded by the proxy server, the redacted signaling message having fewer SIP header fields than a standard SIP message.

33. The computer program product of claim 32, wherein sending a redacted signaling message comprises computer program code for:
omitting at least one of the session header fields of a group of SIP header fields consisting of: Via, Require, Proxy-Require, Supported, Allow, Contact, Content-Type, Max-Forwards, Route, and P-Access-Network-Info.

34. The computer program product of claim 32, wherein sending a redacted signaling message further comprises computer program code for:
omitting at least one of session description parameters for media type supported, wherein the media type is audio or video

35. A device for communicating with another network entity in a communications network, the device comprising:
means for registering with a communications core network through a proxy server using a SIP message;
means for sending a redacted signaling message to a recipient communications terminal through the proxy server, the redacted signaling message having fewer SIP header fields than a standard SIP message; and
means for receiving a redacted signaling message forwarded by the proxy server, the redacted signaling message having fewer SIP header fields than a standard SIP message.

36. The device of claim 35, wherein sending a redacted signaling message comprises means for omitting at least one of the session header fields of a group of SIP header fields consisting of: Via, Require, Proxy-Require, Supported, Allow, Contact, Content-Type, Max-Forwards, Route, and P-Access-Network-Info.

37. The device of claim 35, wherein sending a redacted signaling message further comprises means for omitting at least one of session description parameters for media type supported, wherein the media type is audio or video

38. A system for optimizing call session communications between network terminals in a communications network, the system comprising:
a communications terminal capable of communicating with a remote terminal over a network using redacted signaling messages, the redacted signaling messages having fewer SIP header fields than a standard SIP message; and
a SIP proxy server configured to receive redacted signaling messages from the communications terminal, construct a SIP message therefrom, and forward the SIP message to the remote terminal, the SIP proxy server further configured to receive SIP messages from the remote terminal, redact the SIP message to form a redacted message, and forward the redacted message to the communications terminal.

39. The system of claim 38, wherein the communications terminal is configured to register with a communications core network through the proxy server using SIP messages during a session registration process.

40. The system of claim 38, wherein the SIP proxy server is configured to store session context data in response to the SIP message received from the communications terminal during the session registration process.
